(19) United States
(12) Patent Application Publication
(10) Pub. No.: US 2007/0179016 A1
(43) Pub. Date: Aug. 2, 2007

(54) Engine control apparatus

(75) Inventors: Hiroyasu Honda, Toyota-shi (JP); Masaharu Tanaka, Toyota-shi (JP); Masami Kondo, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi (JP)

(21) Appl. No.: 11/657,479

(22) Filed: Jan. 25, 2007

(30) Foreign Application Priority Data
Jan. 30, 2006 (JP) 2006-020687

(51) Int. Cl. F16H 59/60

(52) U.S. Cl. 477/97

(57) ABSTRACT

In an engine control apparatus, a target engine torque after an environment correction is calculated by interpolating it between an environmentally corrected maximum engine torque and an environmentally corrected minimum engine torque according to a target torque ratio which is a ratio of the target engine torque between the maximum engine torque and the minimum engine torque under a predetermined environmental condition. The maximum engine torque and the minimum engine torque are set based on a smoothed maximum engine torque and a smoothed minimum engine torque obtained by smoothing out a change over time in an estimated maximum engine torque and an estimated minimum engine torque currently able to be output according to a change in the environmental condition.

### INCORPORATION BY REFERENCE

The disclosure of Japanese Patent Application No. 2006-020687 filed on Jan. 30, 2006, including the specification, drawings and abstract is incorporated herein by reference in its entirety.

### BACKGROUND OF THE INVENTION

1. Field of the Invention

The invention relates to an engine control apparatus. More particularly, the invention relates to an engine control apparatus, which obtains a target engine torque based on an operation amount of an accelerator when controlling the driving force of a vehicle, and performs engine control so that the engine torque becomes equal to the target engine torque.

2. Description of the Related Art

A structure is known which obtains a target engine torque based on an accelerator operation amount when controlling the driving force of a vehicle, and performs engine control so that the engine output torque becomes equal to the target engine torque. In this kind of engine control, the engine torque characteristics are obtained beforehand under a predetermined environmental condition, and the engine torque is adjusted based on the target engine torque and the engine torque characteristics obtained beforehand.

However, when the environmental condition changes from the predetermined environmental condition, the actual engine torque characteristics also change such that when the engine torque is adjusted using the engine torque characteristics that were obtained under the predetermined environmental condition, the driving force that is achieved does not accurately reflect the driving force desired by the driver.

Regarding this point, Japanese Patent Application Publication No. JP-A-9-112329 proposes obtaining the maximum engine torque and the minimum engine torque that are actually able to be generated based on an environmental condition such as atmospheric pressure or the intake air temperature, and then obtaining the target engine torque by calculating it by interpolating it between the obtained maximum engine torque and the minimum engine torque.

More specifically, an interpolation block is applied with the target engine torque as a ratio (MPED) between the minimum engine torque and the maximum engine torque. The interpolation block obtains a target engine torque (MFAR) by calculating it by interpolating it between the maximum engine torque (MMAX) and the minimum engine torque (MMIN) that are actually able to be generated, according to that ratio (MPED) (i.e., MFAR=MPED×(MMAX−MMIN)+MMIN). As a result, a target engine torque that corresponds to an accelerator operation by the driver can be set which reflects changes in the environment such as atmospheric pressure or intake air temperature or the like.

However, when the target engine torque is obtained by the method described in Japanese Patent Application Publication No. JP-A-9-112329, the following problems occur. The intake air amount during an accelerator operation is typically controlled to change in a stepped manner following operation of an auxiliary load such as an air conditioner or the like, with the intake air amount setting at which an appropriate engine speed (i.e., idling speed) can be maintained by ISC (Idle Speed Control) as the base. Therefore, the minimum engine torque may change in a stepped manner.

Also, in an engine provided with a system that can change the torque characteristics, such as a variable intake system, the maximum engine torque may change in a stepped manner following a change in the torque characteristics. Therefore, when the accelerator operation amount (i.e., accelerator opening amount) is in the mid opening amount range, the target engine torque may be affected by this stepped change in the minimum engine torque or the maximum engine torque and also change in a stepped manner. If the target engine torque changes in a stepped manner in this way, it no longer changes smoothly which may lead to a deterioration in drivability.

### SUMMARY OF THE INVENTION

A first aspect of the invention relates to an engine control apparatus which obtains a target engine torque based on an accelerator operation amount and performs engine control such that an output torque of an engine becomes equal to the target engine torque, which includes a nominal calculating portion, an estimating portion, a smoothing portion, and a setting portion. The nominal calculating portion calculates a nominal maximum engine torque, a nominal minimum engine torque and a nominal target engine torque based on characteristics of engine torque with respect to an engine speed and the accelerator operation amount obtained in advance under a predetermined environmental condition. The estimating portion estimates a maximum engine torque and a minimum engine torque based on the environmental condition. The smoothing portion smoothes out a change over time in the estimated minimum engine torque to obtain a smoothed minimum engine torque, and sets an environmentally corrected minimum engine torque based on the smoothed minimum engine torque. The setting portion sets the target engine torque by interpolating it between the estimated maximum engine torque and the environmentally corrected minimum engine torque such that the ratio of the nominal target engine torque between the nominal maximum engine torque and the nominal minimum engine torque becomes essentially equal to the ratio of the target engine torque between the estimated maximum engine torque and the environmentally corrected minimum engine torque.

According to this first aspect, even if the minimum engine torque changes in a stepped manner, the target engine torque when the accelerator operation amount is in the mid opening amount region changes gradually. As a result, the target engine torque can be prevented from changing in a stepped manner and instead change gradually so good drivability can be maintained.

Alternatively, a second aspect of the invention relates to an engine control apparatus which obtains a target engine torque based on an accelerator operation amount and performs engine control such that an output torque of an engine becomes equal to the target engine torque, which includes a nominal calculating portion, an estimating portion, a smoothing portion, and a setting portion. The nominal calculating portion calculates a nominal maximum engine torque, a nominal minimum engine torque and a nominal target engine torque based on characteristics of engine torque with respect to an engine speed and the accelerator operation amount obtained in advance under a predetermined environmental condition. The estimating portion estimates a maximum engine torque and an estimated minimum engine torque based on the environmental condition. The smoothing portion smoothes out a change over time in the estimated maximum engine torque to obtain a smoothed maximum engine torque, and sets an environmentally corrected maximum engine torque based on the smoothed maximum engine torque. The setting portion sets the target engine torque by interpolating it between the environmentally corrected maximum engine torque and the estimated minimum engine torque such that the ratio of the nominal target engine torque between the nominal maximum engine torque and the nominal minimum engine torque becomes essentially equal to the ratio of the target engine torque between the environmentally corrected maximum engine torque and the estimated minimum engine torque.

According to this second aspect, even if the maximum engine torque changes in a stepped manner, the target engine torque when the accelerator operation amount is in the mid opening amount region changes gradually. As a result, the target engine torque can be prevented from changing in a stepped manner and instead change gradually so good drivability can be maintained.

Also, a third aspect of the invention relates to an engine control apparatus which obtains a target engine torque based on an accelerator operation amount and performs engine control such that an output torque of an engine becomes equal to the target engine torque, which includes a nominal calculating portion, an estimating portion, a smoothing portion, and a setting portion. The nominal calculating portion calculates a nominal maximum engine torque, a nominal minimum engine torque and a nominal target engine torque based on characteristics of engine torque with respect to an engine speed and the accelerator operation amount obtained in advance under a predetermined environmental condition. The estimating portion estimates a maximum engine torque and a minimum engine torque based on the enviromnental condition. The smoothing portion smoothes out a change over time in the estimated maximum engine torque and the estimated minimum engine torque to obtain a smoothed maximum engine torque and a smoothed minimum engine torque, respectively, and sets an environmentally corrected maximum engine torque and an environmentally corrected minimum engine torque based on the smoothed maximum engine torque and the smoothed minimum engine torque, respectively. The setting portion sets the target engine torque by interpolating it between the environmentally corrected maximum engine torque and the environmentally corrected minimum engine torque such that the ratio of the nominal target engine torque between the nominal maximum engine torque and the nominal minimum engine torque becomes essentially equal to the ratio of the target engine torque between the environmentally corrected maximum engine torque and the environmentally corrected minimum engine torque.

According to this third aspect, even if the minimum engine torque and the maximum engine torque change in a stepped manner, the target engine torque when the accelerator operation amount is in the mid opening amount region changes gradually. As a result, the target engine torque can be prevented from changing in a stepped manner and instead change gradually so good drivability can be maintained.

### BRIEF DESCRIPTION OF THE DRAWINGS

The foregoing and/or further objects, features and advantages of the invention will become apparent from the following description of example embodiments with reference to the accompanying drawings, in which the same or corresponding portions are denoted by the same reference numerals and wherein:

FIG. 1 is a block diagram of the configuration of an engine ECU which serves as the engine control apparatus according to an example embodiment of the invention;

FIG. 2 is a flowchart illustrating the control structure of a routine for setting the target engine torque according to the example embodiment;

FIG. 3 is a conceptual diagram of an example of a conversion characteristic of an accelerator opening amount;

FIG. 4 is a conceptual diagram of an example structure of a nominal torque map showing the engine torque characteristics with respect to the converted accelerator opening amount and the engine speed under a predetermined environmental condition;

FIG. 5 is a conceptual diagram illustrating an example of the affect of atmospheric pressure on the maximum engine torque;

FIG. 6 is a conceptual diagram showing the details of the calculation of the environmentally corrected target engine torque;

FIGS. 7A and 7B are a conceptual diagrams of a smoothing process on the changes over time in the minimum engine torque and maximum engine torque, respectively; and

FIG. 8 is a conceptual diagram of an example of a target engine torque setting according to this example embodiment.

### DETAILED DESCRIPTION OF THE EXAMPLE EMBODIMENTS

Hereinafter; example embodiments of the invention will be described in detail with reference to the accompanying drawings. The same or corresponding portions in the drawings will be denoted by like reference numerals and descriptions thereof will essentially not be repeated.

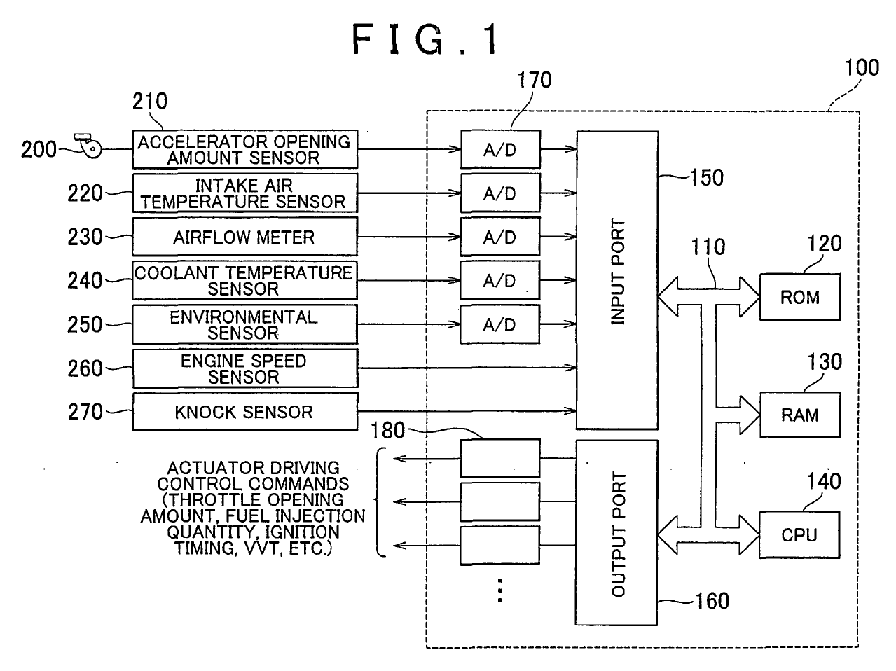

FIG. 1 is a block diagram of the configuration of an engine ECU 100 which serves as the engine control apparatus according to an example embodiment of the invention.

Referring to FIG. 1, an engine ECU is typically formed by a digital computer, including ROM (Read Only Memory) 120, RAM (Random Access Memory) 130, a CPU (Central Processing Unit) 140, and an input port 150 and an output port 160, all of which are interconnected via a bi-directional bus 110.

An accelerator opening amount sensor 210 that generates an output voltage corresponding to a depression amount (i.e., an accelerator opening amount or accelerator operation amount) of an accelerator pedal 200 that is operated by a driver is connected to the accelerator pedal 200. An intake air temperature sensor 220 is provided in an intake air pipe, not shown, and outputs a voltage corresponding to the temperature of the intake air. An airflow meter 230 outputs a voltage corresponding to the amount of intake air introduced by a throttle valve, not shown, which is driven by an electric motor, also not shown. In this example embodiment, the opening amount of the throttle valve, not shown, is not directly controlled by the accelerator pedal 200, but rather based on an output signal from the engine ECU 100.

A coolant temperature sensor 240 is provided which outputs a voltage corresponding to the temperature of engine coolant. An environmental sensor 250 is also provided which detects the environment around the vehicle in which the engine is mounted (e.g., altitude, atmospheric pressure, gradient, outside air temperature, and the like). The output voltages from these sensors 210 to 250 are input to the input port 150 via an A/D converter 170.

An engine speed sensor 260 that generates an output pulse indicative of the engine speed is connected to the input port 150. Also, output from a knock sensor 270 that detects knocking in the engine is also input to the input port 150. In FIG. 1, only the sensors used in the environmental correction in the target engine torque setting calculation according to this example embodiment of the invention are representatively shown. Other sensors necessary for performing engine control are also actually provided, however.

The engine ECU 100 generates various kinds of control signals for controlling operation of the overall engine system based on signals from these sensors by executing predetermined programs. These control signals are generated as driving control commands for various actuators (e.g., throttle valve, fuel injection injectors, spark plug driving circuit, a variable valve timing (VVT) mechanism, and the like) for performing engine control via the output port 160 and signal driving circuits 180.

In this example embodiment of the invention, the engine ECU 100 controls the driving force of the vehicle according to the so-called torque demand method. That is, the engine ECU 100 sets a target engine torque that is based on the accelerator operation amount and controls the throttle opening amount and the ignition timing and the like so that the actual engine torque becomes equal to the target engine torque, as will be described below.

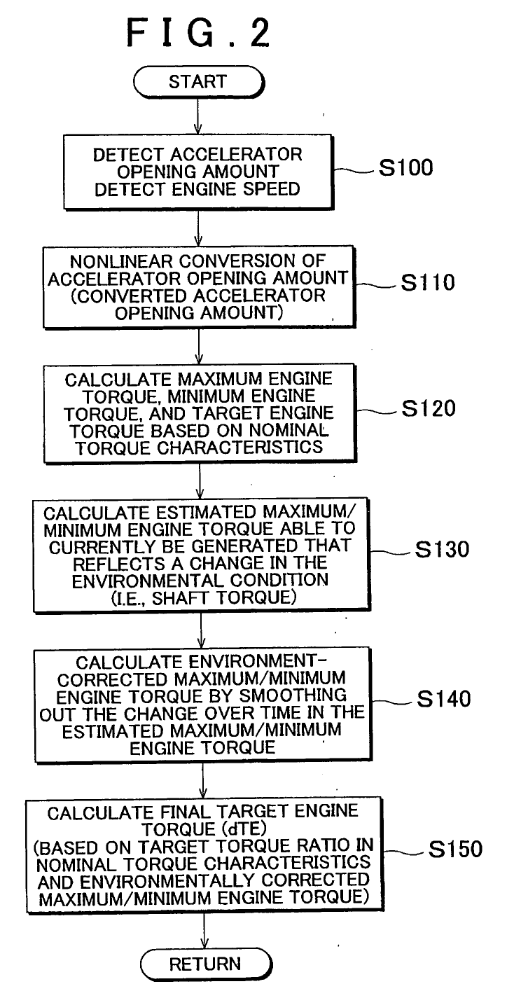

Next, the control structure of a routine for setting the target engine torque according to the example embodiment of the invention will be described with reference to FIG. 2. The engine ECU 100 sets the target engine torque according to the flowchart shown in FIG. 2 at predetermined time cycles.

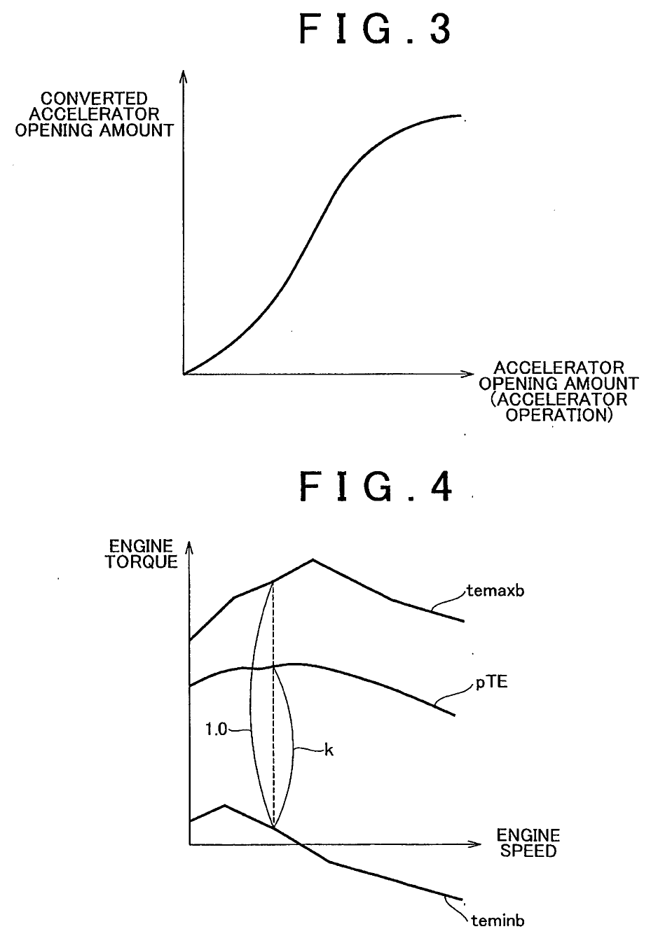

In step S100 the engine ECU 100 detects the accelerator opening amount and the engine speed based on the outputs from the accelerator opening amount sensor 210 and the engine speed sensor 260. Then in step S110 the engine ECU 100 obtains a converted accelerator opening amount by nonlinearly converting the accelerator opening amount according to the conversion characteristic shown in FIG. 3.

Referring to FIG. 3, the converted accelerator opening amount sets the output characteristic with respect to an accelerator operation. The nonlinear conversion characteristic between the accelerator operation amount and the converted accelerator opening amount is set to have a convex shape in the lower part of the accelerator low opening amount region in order to improve the acceleration feeling when the driver depresses the accelerator pedal, and set to have a characteristic in which the output gradually reaches maximum output in the accelerator high opening amount region. The nonlinear converted characteristic shown in FIG. 3 is set individually for each gear speed (not shown in the drawing). Also, in this example embodiment of the invention, the accelerator opening amount conversion shown in FIG. 3 is executed in order to improve drivability. However, this accelerator opening amount conversion is not absolutely necessary in the control for setting the target engine torque according to this invention.

Referring back to FIG. 2, the engine ECU 100 calculates the maximum torque (hereinafter referred to as “nominal maximum engine torque”), the minimum torque (hereinafter referred to as “nominal minimum engine torque”), and the target torque (hereinafter referred to as “nominal target engine torque”) under a predetermined environment based on the nominal characteristics (FIG. 4) obtained in advance under a predetermined environment as well as the current engine speed and converted accelerator opening amount (S110) in step S120.

The nominal characteristics are the engine torque characteristics obtained in advance under a predetermined environmental condition. Control constants and the like are also applied to control of the various devices for adjusting engine torque based on the engine torque characteristics under the predetermined environmental condition.

Referring to FIG. 4, the engine torque characteristics with respect to the engine speed and converted accelerator opening amount under the predetermined environmental condition are mapped out in a nominal torque map. Therefore, a nominal maximum engine torque temaxb corresponding to when the accelerator is fully open, a nominal minimum target engine torque teminb corresponding to when the accelerator is fully closed, and a nominal target engine torque pTE corresponding to the current converted accelerator opening amount are obtained from the current engine speed and accelerator operation amount. The nominal target engine torque pTE is set so that it is interpolated between the nominal minimum engine torque teminb and the nominal maximum engine torque temaxb. The nominal maximum engine torque temaxb, the nominal minimum engine torque teminb, and the nominal target engine torque pTE in FIG. 4 are output as shaft torque.

Here, the ratio of the nominal target engine torque pTE between the nominal minimum engine torque teminb and the nominal maximum engine torque temaxb, i.e., the target torque ratio k in the nominal characteristics, can be expressed as shown in Expression (1) below.

k=(pTE−teminb)/(temaxb−teminb) (1)

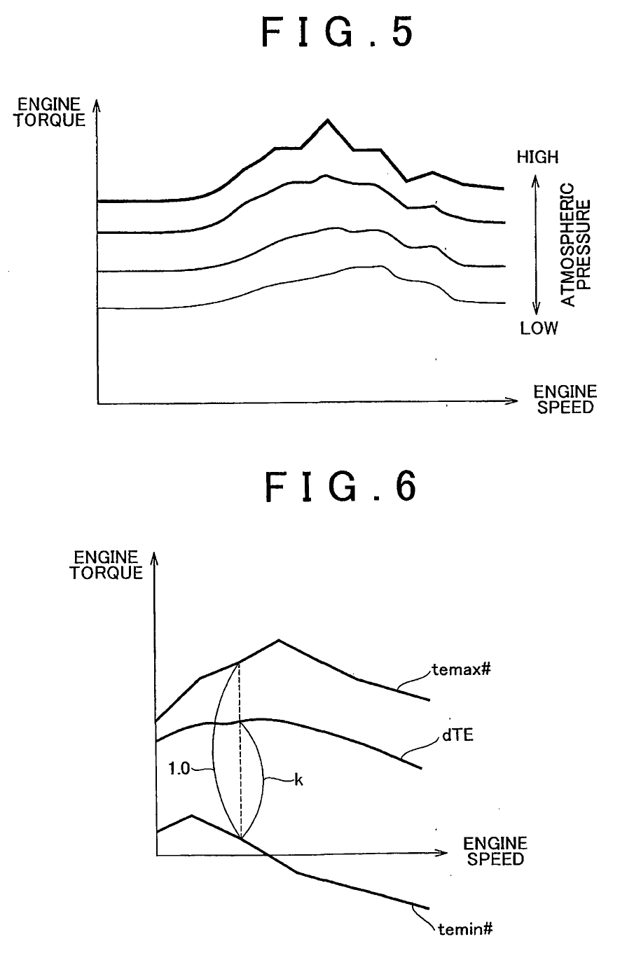

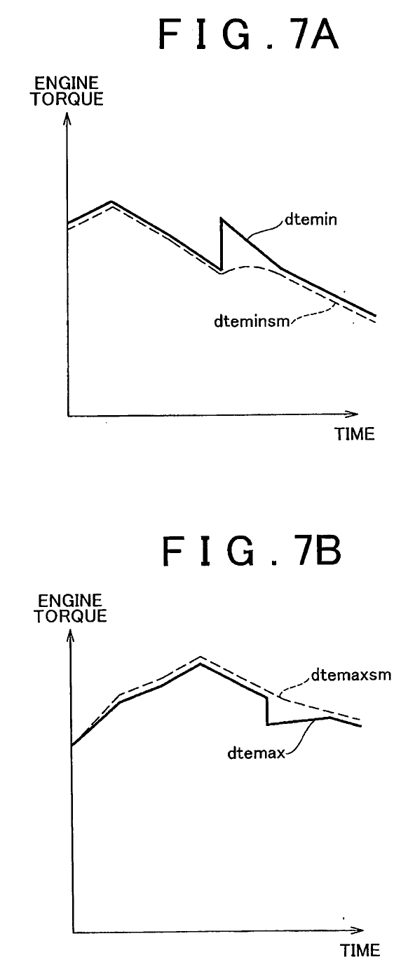

The engine torque characteristics change when the environmental condition, represented by atmospheric pressure, changes. For example, the maximum engine torque that can be output decreases when there is a decrease in atmospheric pressure, as shown in FIG. 5.

Referring back to FIG. 2 again, in step S130 the engine ECU 100 obtains a current estimated minimum engine torque dtemin and a current estimated maximum engine torque dtemax of the engine based on the engine state and an environmental condition such as the atmospheric pressure, the intake air temperature or the like. The environmental condition can be obtained from the intake air temperature sensor 220 or the environmental sensor 250 shown in FIG. 1, for example. The atmospheric pressure can also be estimated by comparing the current intake air amount measured by the airflow meter 230 while the throttle valve is opened a predetermined amount with reference intake air amount (when on level ground) while the throttle valve is opened at the same predetermined amount.

The ISC (Idle Speed Control) throttle opening amount, the engine speed, the ignition timing, the knocking learning, the variable valve timing (VVT) state, and the variable intake pipe state and the like are reflected as the engine state in the calculation of the estimated minimum engine torque dtemin. Also, the fully open throttle opening amount, the engine speed, the ignition timing, the knocking learning, the variable valve timing (VVT) state, and the variable intake pipe state and the like are reflected as the engine state in the calculation of the estimated maximum engine torque dtemax.

In step S130, the engine ECU 100 calculates the estimated minimum engine torque dtemin and the estimated maximum engine torque dtemax by subtracting the engine friction torque and the auxiliary torque from the thus obtained minimum and maximum engine torques, and converting the differences to axial torque.

Then in step S140, the engine ECU 100 calculates an environmentally corrected (i.e., a correction to account for a change in the environmental condition) maximum engine torque temax# and an environmentally corrected minimum engine torque temin# by smoothing out the change over time in the maximum/minimum engine torques dtemin/dtemax estimated in step S130.

Then in step S150, the engine ECU 100 calculates an environmentally corrected final target engine torque dTE based on the environmentally corrected maximum engine torque temax# and environmentally corrected minimum engine torque temin# that were obtained in step S140, as well as the target torque ratio k in the nominal characteristics in step S120.

Here, the calculation of the environment-calculated target engine torque dTE will be described in detail with reference to FIG. 6.

Referring to FIG. 6, the final target engine torque dTE is set according to Expression (2) below so that it is interpolated such that the ratio of the difference between the final target engine torque dTE and the environmentally corrected minimum engine torque temin# to the difference between the environmentally corrected maximum engine torque temax# and the environmentally corrected minimum engine torque temin# becomes equal to the target torque ratio k in the nominal characteristics.

dTE=(temax#−temin#)×k+temin# (2)

Here, k=(pTE−teminb)/temaxb−teminb), as shown in Expression (1).

The engine ECU 100 generates an actuator driving control command to execute engine control of the throttle opening amount and the ignition timing and the like in order to realize the final target engine torque dTE that was set in step S150 in FIG. 2.

Next, the method for calculating the environmentally corrected maximum engine torque temax# and the environmentally corrected minimum engine torque temin# in step S140 will be described in detail.

As shown in FIG; 7, a smoothed out minimum engine torque dteminsm is obtained based on the estimated minimum engine torque dtemin by reflecting only part of the change in the estimated minimum engine torque dtemin in the updated minimum engine torque dteminsm according to a predetermined smoothing degree. For example, the smoothed minimum engine torque dteminsm is obtained according to Expression (3) below. However, the term ksm in Expression (3) is a predetermined smoothing degree (ksm<1.0).

dteminsm(current value)=(1−ksm)×dtemin+ksm×dteminsm(last value) (3)

Similarly, the smoothed maximum engine torque dtemaxsm is obtained based on the estimated maximum engine torque dtemax so that only part of the change in the estimated maximum engine torque dtemax is reflected in the updated maximum engine torque dtemaxsm. For example, the smoothed maximum engine torque dtemaxsm is obtained according to Expression (4) below. The smoothing degree ksm (ksm<1.0) in Expression (4) may be the same or different as that in Expression (3).

dtemaxsm(current value)=(1−ksm)×dtemax+ksm×dtemaxsm(last value) (4)

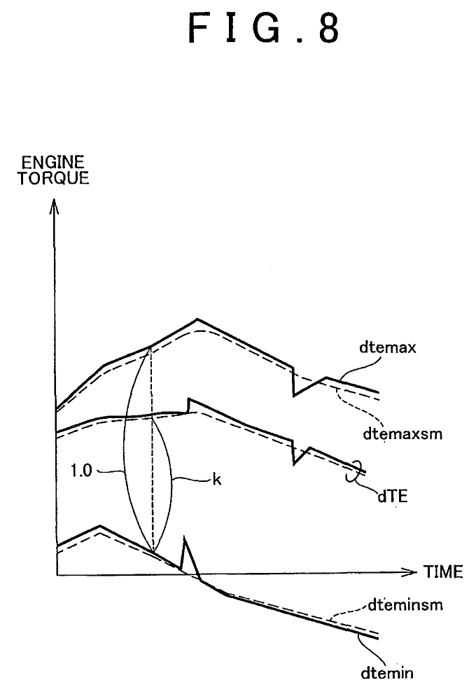

Referring to FIG. 8, even if there is a step-like change in the estimated maximum engine torque dtemax and the estimated minimum engine torque dtemin, as shown by the solid line, performing the processing in Expressions (3) and (4) changes the maximum engine torque dtemaxsm and the minimum engine torque dteminsm, in which the changes over time have been smoothed out, in a gradual manner as shown by the dotted line, instead of a step-like manner.

The maximum engine torque temax# and minimum engine torque temin# for calculating the environmentally corrected target engine torque dTE are set based on the smoothed maximum engine torque dtemaxsm and smoothed minimum engine torque dteminsm. As a result, even if the maximum engine torque dtemax and/or the minimum engine torque dtemin change in a stepped manner, the target engine torque dTE is prevented from changing in a stepped manner and thus changes smoothly, as shown by the dotted line in FIG. 8, particularly in the accelerator mid opening amount region, such that good drivability can be maintained.

Furthermore, in this example embodiment, the degree to which the change over time in the maximum/minimum engine torque is smoothed out is variably set according to the accelerator opening amount, as will be described below.

In step S140, the engine ECU 100 obtains the environmentally corrected maximum engine torque temax# and environmentally corrected minimum engine torque temin# using the maximum/minimum engine torque in which the change over time has been smoothed out, by the process according to Expressions (5) to (8) below.

temin#=Rn×dtemin+(1−Rn)×dteminsm (5)

Rn=(PL−AC)/PL (6)

temax#=Rx×dtemax+(1−Rx)×dtemaxsm (7)

Rx=(AC−PH)/(FAC−PH) (8)

In Expression (6), AC is the converted accelerator opening amount and PL is a threshold value of the accelerator low opening amount region. In Expression (8), PH is a threshold value of the accelerator high opening amount and FAC is the converted accelerator opening amount when the accelerator is fully open.

Also, coefficient Rn in Expression (6) is guarded within the range of 0≦Rn ≦1. Similarly, coefficient Rx in Expression (8) is guarded within the range of 0≦Rx≦1.

However, as can be understood from Expression (6), in the accelerator mid opening amount region in which the converted accelerator opening amount AC is equal to or greater than the threshold value PL, the coefficient Rn becomes equal to 0 and the minimum engine torque dteminsm in which the change over time was smoothed out is used as the environmentally corrected minimum engine torque temin#. That is, temin# is made equal to dteminsm.

In contrast, in the accelerator low opening amount region in which the converted accelerator opening amount AC is less than the threshold PL, the coefficient Rn becomes greater than 0 (and Rn≦1), and the environmentally corrected minimum engine torque temin# is calculated from the estimated minimum engine torque dtemin of step S130 and the smoothed minimum engine torque dteminsm of step S140 so that the weighting factor of the estimated minimum engine torque dtemin increases the lower the converted accelerator opening amount.

When the converted accelerator opening amount AC is at the minimum amount, i.e., when the accelerator is fully closed (i.e., depression rate=0), Rn is set to equal 1. As a result, the estimated minimum engine torque dtemin is used as it is as, i.e., without the change over time being smoothed out, as the environmentally corrected minimum engine torque temin#. That is, temin# is set to equal dtemin, and the minimum engine torque currently able to be output that is estimated reflecting the environmental condition can be set to the environmentally corrected minimum engine torque temin#.

The environmentally corrected minimum engine torque (temin#) is obtained in step S140 by further executing Expressions (5) and (6) above. This is equivalent to variably setting the degree to which the change over time is smoothed out (i.e., the smoothing degree) according to the accelerator opening amount. More specifically, when the accelerator opening amount is equal to or less than the predetermined amount PL, the estimated minimum engine torque dtemin is reflected in the environmentally corrected minimum engine torque temin# with a heavily weighted factor such that the smoothing degree (of the change over time) essentially becomes smaller as the accelerator opening amount decreases.

As a result, when the accelerator is fully closed or in a region near there, in which case it is desirable that the target engine torque follow the step-like change in the minimum engine torque, the engine target torque can be set to reflect a change in the minimum engine torque that corresponds to a change in the environmental condition or engine state. A step-like change in the minimum engine torque mainly occurs due to a change in the ISC throttle opening amount according to the state of an auxiliary load such as an air conditioner.

Similalry, as can be understood from Expression (8), in the accelerator mid opening amount region in which the converted accelerator opening amount AC is equal to or less than the threshold PH, the coefficient Rx becomes equal to 0 so the maximum engine torque dtemaxsm in which the change over time has been smoothed out is used as the environmentally corrected maximum engine torque temax #. That is, temax# is made equal to dtemaxsm.

In contrast, in the accelerator high opening amount region in which the converted accelerator opening amount AC is greater than the threshold PH, the coefficient Rx becomes greater than 0 (and Rn≦1), and the environmentally corrected maximum engine torque temax# is calculated from the estimated maximum engine torque dtemax that was calculated in step S130 and the smoothed maximum engine torque dtemaxsm that was calculated in step S140 so that the weighting factor of the estimated maximum engine torque dtemax increases the greater the converted accelerator opening amount.

When the converted accelerator opening amount AC is at the maximum amount, i.e., when the accelerator is fully open (i.e., the maximum depression amount), Rx is set to equal 1. As a result, the estimated maximum engine torque dtemax is used as it is as, i.e., without the change over time being smoothed out, as the environmentally corrected maximum engine torque temax#. That is, temax# is set to equal dtemax, and the maximum engine torque currently able to be output that was estimated reflecting the environmental condition can be set to the environmentally corrected maximum engine torque temax#.

The environmentally corrected maximum engine torque (temax#) is obtained in step S140 by further executing Expressions (7) and (8) above. This is equivalent to variably setting the degree to which the change over time is smoothed out (i.e., the smoothing degree) according to the accelerator opening amount. More specifically, when the accelerator opening amount is equal to or greater than the predetermined amount PH, the estimated maximum engine torque dtemax is reflected in the maximum engine torque temax# that was environmentally corrected with the heavily weighted factor such that the smoothing degree (of the change over time) essentially becomes smaller as the accelerator opening amount increases.

As a result, when the accelerator is fully open or in a region near there, in which case it is desirable that the target engine torque follow the step-like change in the maximum engine torque, the engine target torque can be set to reflect a change in the maximum engine torque that corresponds to a change in the environmental condition or engine state. A step-like change in the maximum engine torque mainly occurs when an intake pipe is switched in an engine provided with a variable intake system.

By performing the above control processes, the target engine torque can still be changed smoothly even if the maximum engine torque and/or the minimum engine torque changes in a stepped manner in the accelerator mid opening amount region. On the other hand, the target engine torque can be set to follow the stepped change of the maximum engine torque and/or the minimum engine torque in the accelerator fully open and fully closed regions as well as near those regions, in which case it is desirable to appropriately reflect the change in the maximum engine torque and minimum engine torque following a change in the environmental condition or engine state.

Depending on the type of engine and the like, in step S140, the smoothing process described above does not have to be performed for both the estimated maximum engine torque dtemax and the estimated minimum engine torque dtemin calculated in step S130, i.e., a control structure may also be used which executes the foregoing smoothing process for only one of the maximum engine torque and minimum engine torque.

Also, the smoothing process in step SI40 is not limited to the processes in Expressions (3) to (8) as long as the process similarly smoothes out a change over time in the maximum/minimum engine torque, or in addition thereto, enables the same degree of smoothing to be variably set according to the accelerator opening amount.

In the flowchart shown in FIG. 2, step S120 can be regarded as a “nominal calculating portion” of the invention, step S130 can be regarded as an “estimating portion” of the invention, step S140 can be regarded as a “smoothing portion” of the invention, and step S150 can be regarded as a “setting portion” of the invention.

The example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

What is claimed is:

1. An engine control apparatus which obtains a target engine torque based on an accelerator operation amount and performs engine control such that an output torque of an engine becomes equal to the target engine torque, comprising:
a nominal calculating portion that calculates a nominal maximum engine torque, a nominal minimum engine torque and a nominal target engine torque based on characteristics of engine torque with respect to an engine speed and the accelerator operation amount obtained in advance under a predetermined environmental condition;
an estimating portion that estimates a maximum engine torque and a minimum engine torque based on the environmental condition;
a smoothing portion which smoothes out a change over time in the estimated minimum engine torque to obtain a smoothed minimum engine torque, and sets an environmentally corrected minimum engine torque based on the smoothed minimum engine torque; and
a setting portion that sets the target engine torque by interpolating the target engine torque between the estimated maximum engine torque and the environmentally corrected minimum engine torque such that the ratio of the nominal target engine torque between the nominal maximum engine torque and the nominal minimum engine torque becomes essentially equal to the ratio of the target engine torque between the estimated maximum engine torque and the environmentally corrected minimum engine torque.

2. The engine control apparatus according to claim 1, wherein the setting portion sets the target engine torque by interpolating the target engine torque between the estimated maximum engine torque and the environmentally corrected minimum engine torque such that the ratio of the difference between the nominal maximum engine torque and the nominal minimum engine torque to the difference between the nominal target engine torque and the nominal minimum engine torque becomes essentially equal to the ratio of the difference between the estimated maximum engine torque and the environmentally corrected minimum engine torque to the difference between the target engine torque and the environmentally corrected minimum engine torque.

3. An engine control apparatus which obtains a target engine torque based on an accelerator operation amount and performs engine control such that an output torque of an engine becomes equal to the target engine torque, comprising:
a nominal calculating portion that calculates a nominal maximum engine torque, a nominal minimum engine torque and a nominal target engine torque based on characteristics of engine torque with respect to an engine speed and the accelerator operation amount obtained in advance under a predetermined environmental condition;
an estimating portion that estimates a maximum engine torque and a minimum engine torque based on the environmental condition;
a smoothing portion which smoothes out a change over time in the estimated maximum engine torque to obtain a smoothed maximum engine torque, and sets an environmentally corrected maximum engine torque based on the smoothed maximum engine torque; and
a setting portion that sets the target engine torque by interpolating the target engine torque between the environmentally corrected maximum engine torque and the estimated minimum engine torque such that the ratio of the nominal target engine torque between the nominal maximum engine torque and the nominal minimum engine torque becomes essentially equal to the ratio of the target engine torque between the environmentally corrected maximum engine torque and the estimated minimum engine torque.

4. The engine control apparatus according to claim 3, wherein the setting portion sets the target engine torque by interpolating the target engine torque between the environmentally corrected maximum engine torque and the estimated minimum engine torque such that the ratio of the difference between the nominal maximum engine torque and the nominal minimum engine torque to the difference between the nominal target engine torque and the nominal minimum engine torque becomes essentially equal to the ratio of the difference between the environmentally corrected maximum engine torque and the estimated minimum engine torque to the difference between the target engine torque and the estimated minimum engine torque.

5. An engine control apparatus which obtains a target engine torque based on an accelerator operation amount and performs engine control such that an output torque of an engine becomes equal to the target engine torque, comprising:
a nominal calculating portion that calculates a nominal maximum engine torque, a nominal minimum engine torque and a nominal target engine torque based on characteristics of engine torque with respect to an engine speed and the accelerator operation amount obtained in advance under a predetermined environmental condition;
an estimating portion that estimates a maximum engine torque and a minimum engine torque based on the environmental condition;
a smoothing portion which smoothes out a change over time in the estimated maximum engine torque and the estimated minimum engine torque to obtain a smoothed maximum engine torque and a smoothed minimum engine torque, respectively, and sets an environmentally corrected maximum engine torque and an environmentally corrected minimum engine torque based on the smoothed maximum engine torque and the smoothed minimum engine torque, respectively; and
a setting portion that sets the target engine torque by interpolating the target engine torque between the environmentally corrected maximum engine torque and the environmentally corrected minimum engine torque such that the ratio of the nominal target engine torque between the nominal maximum engine torque and the nominal minimum engine torque becomes essentially equal to the ratio of the target engine torque between the environmentally corrected maximum engine torque and the environmentally corrected minimum engine torque.

6. The engine control apparatus according to claim 5, wherein the setting portion sets the target engine torque by interpolating the target engine torque between the environmentally corrected maximum engine torque and the environmentally corrected minimum engine torque such that the ratio of the difference between the nominal maximum engine torque and the nominal minimum engine torque to the difference between the nominal target engine torque and the nominal minimum engine torque becomes essentially equal to the ratio of the difference between the environmentally corrected maximum engine torque and the environmentally corrected minimum engine torque to the difference between the target engine torque and the environmentally corrected minimum engine torque.

7. The engine control apparatus according to claim 1, wherein the smoothing portion smoothes out a change over time in the estimated minimum engine torque according to a predetermined smoothing degree; and the smoothing degree is set, according to the accelerator operation amount, smaller when the accelerator operation amount is less than a predetermined value than when the accelerator operation amount is equal to or greater than the predetermined value.

8. The engine control apparatus according to claim 5, wherein the smoothing portion smoothes out a change over time in the estimated minimum engine torque according to a predetermined smoothing degree; and the smoothing degree is set, according to the accelerator operation amount, smaller when the accelerator operation amount is less than a predetermined value than when the accelerator operation amount is equal to or greater than the predetermined value.

9. The engine control apparatus according to claim 1, wherein when the accelerator operation amount is minimal, the smoothing portion sets the estimated minimum engine torque, instead of the smoothed minimum engine torque, to the environmentally corrected minimum engine torque used by the setting portion.

10. The engine control apparatus according to claim 5, wherein when the accelerator operation amount is minimal, the smoothing portion sets the estimated minimum engine torque, instead of the smoothed minimum engine torque, to the environmentally corrected minimum engine torque used by the setting portion.

11. The engine control apparatus according to claim 3, wherein the smoothing portion smoothes out a change over time in the estimated maximum engine torque according to a predetermined smoothing degree; and the smoothing degree is set, according to the accelerator operation amount, smaller when the accelerator operation amount is greater than a predetermined value than when the accelerator operation amount is equal to or less than the predetermined value.

12. The engine control apparatus according to claim 5, wherein the smoothing portion smoothes out a change over time in the estimated maximum engine torque according to a predetermined smoothing degree; and the smoothing degree is set, according to the accelerator operation amount, smaller when the accelerator operation amount is greater than a predetermined value than when the accelerator operation amount is equal to or less than the predetermined value.

13. The engine control apparatus according to claim 3, wherein when the accelerator operation amount is maximal, the smoothing portion sets the estimated maximum engine torque, instead of the smoothed maximum engine torque, to the environmentally corrected maximum engine torque used by the setting portion.

14. The engine control apparatus according to claim 5, wherein when the accelerator operation amount is maximal, the smoothing portion sets the estimated maximum engine torque, instead of the smoothed maximum engine torque, to the environmentally corrected maximum engine torque used by the setting portion.

15. An engine control apparatus which obtains a target engine torque based on an accelerator operation amount and performs engine control such that an output torque of an engine becomes equal to the target engine torque, comprising:
nominal calculating means for calculating a nominal maximum engine torque, a nominal minimum engine torque and a nominal target engine torque based on characteristics of engine torque with respect to an engine speed and the accelerator operation amount obtained in advance under a predetermined environmental condition;
estimating means for estimating a maximum engine torque and a minimum engine torque based on the environmental condition;
smoothing means for smoothing out a change over time in the estimated minimum engine torque to obtain a smoothed minimum engine torque, and setting an environmentally corrected minimum engine torque based on the smoothed minimum engine torque; and
setting means for setting the target engine torque by interpolating the target engine torque between the estimated maximum engine torque and the environmentally corrected minimum engine torque such that the ratio of the nominal target engine torque between the nominal maximum engine torque and the nominal minimum engine torque becomes essentially equal to the ratio of the target engine torque between the estimated maximum engine torque and the environmentally corrected minimum engine torque.

16. An engine control apparatus which obtains a target engine torque based on an accelerator operation amount and performs engine control such that an output torque of an engine becomes equal to the target engine torque, comprising:
nominal calculating means for calculating a nominal maximum engine torque, a nominal minimum engine torque and a nominal target engine torque based on characteristics of engine torque with respect to an engine speed and the accelerator operation amount obtained in advance under a predetermined environmental condition;
estimating means for estimating a maximum engine torque and a minimum engine torque based on the environmental condition;
smoothing means for smoothing out a change over time in the estimated maximum engine torque to obtain a smoothed maximum engine torque, and setting an environmentally corrected maximum engine torque based on the smoothed maximum engine torque; and
setting means for setting the target engine torque by interpolating the target engine torque between the environmentally corrected maximum engine torque and the estimated minimum engine torque such that the ratio of the nominal target engine torque between the nominal maximum engine torque and the nominal minimum engine torque becomes essentially equal to the ratio of the target engine torque between the environmentally corrected maximum engine torque and the estimated minimum engine torque.

17. An engine control apparatus which obtains a target engine torque based on an accelerator operation amount and performs engine control such that an output torque of an engine becomes equal to the target engine torque, comprising:
nominal calculating means for calculating a nominal maximum engine torque, a nominal minimum engine torque and a nominal target engine torque based on characteristics of engine torque with respect to an engine speed and the accelerator operation amount obtained in advance under a predetermined environmental condition;
estimating means for estimating a maximum engine torque and a minimum engine torque based on the environmental condition;
smoothing means for smoothing out a change over time in the estimated maximum engine torque and the estimated minimum engine torque to obtain a smoothed maximum engine torque and a smoothed minimum engine torque, respectively, and setting an environmentally corrected maximum engine torque and an environmentally corrected minimum engine torque based on the smoothed maximum engine torque and the smoothed minimum engine torque, respectively; and
setting means for setting the target engine torque by interpolating the target engine torque between the environmentally corrected maximum engine torque and the environmentally corrected minimum engine torque such that the ratio of the nominal target engine torque between the nominal maximum engine torque and the nominal minimum engine torque becomes essentially equal to the ratio of the target engine torque between the environmentally corrected maximum engine torque and the environmentally corrected minimum engine torque.
